(19) United States
(12) Patent Application Publication
(10) Pub. No.: US 2006/0237464 A1
(43) Pub. Date: Oct. 26, 2006

(54) Vehicle vacuum flask

(76) Inventor: Kao-Man Lin, Shulin City (TW)

Correspondence Address: Kao-Man LIN, P.O. Box 6-57, Junghe, Taipei 235, TW

(21) Appl. No.: 11/114,141

(22) Filed: Apr. 26, 2005

(51) Int. Cl. A47J 41/00

(52) U.S. Cl. 220/592.27

(57) ABSTRACT

A vehicle vacuum flask has a body, a liner, a fixing frame, a temperature controlling unit and a bottom lid. A temperature controlling unit includes a chip, a thermal element and a fan. A bottom lid encloses an end of the body. The bottom lid has a first wall and a second wall. Retention holes are defined in the first wall, and retention elements extend through a fixing holes of the first wall. A partitioning wall is formed on substantially a middle of the second wall and defines a slot for corresponding to the fan. First thermal holes are defined in the second wall and second thermal holes are defined in the first wall. Thus the bottom lid is reliably assembled and easily detached. Meanwhile the vacuum flask can give out heat preferably.

### BACKGROUND OF THE INVENTION

(a) Field of the Invention

The present invention relates to an improved vacuum flask, and particularly to a vacuum flask used in vehicle.

(b) Description of the Prior Art

A conventional vehicle vacuum flask generally comprises a body, a lid and a temperature controlling device. The body includes a cavity for holding liquid. The lid covers an end of the cavity. The temperature controlling device is sealed inside the body. A sealing plate glues to an end of the body for sealing the temperature controlling device inside the body. A plurality of thermal holes is defined in the body and corresponding to the temperature controlling device for giving out heat produced by the temperature controlling device. The temperature controlling device electrically connects with a vehicle power supply for heat preservation. Moreover, the vacuum flask gives out heat from the thermal holes, so some thermal holes at a bottom thereof will be obstructed when the vacuum flask stands upright, and some thermal holes at a side thereof will be obstructed when the vacuum flask is lying.

However, the sealing plate glues to the body to seal the temperature controlling device, so the temperature controlling device can not be detached for repairing when it is out of work. The body is damaged once the sealing plate is removed. Moreover, some thermal holes at a bottom of the vacuum flask may be obstructed when the vacuum flask stands upright; while some thermal holes at a side of the vacuum flask may be obstructed when the vacuum flask is lying. Therefore, the heat produced by the temperature controlling device can not be given out timely.

### SUMMARY OF THE INVENTION

Accordingly, an object of the present invention is to provide a vacuum flask which has a bottom lid reliably assembled and easily detached.

Another object of the present invention is to provide a vacuum flask which defines thermal holes corresponding to the bottom lid thereby effectively giving out heat.

The vacuum flask of the present invention comprises a body, a liner, a fixing frame, a temperature controlling unit and a bottom lid. The body forms a preservation layer on an inner peripheral thereof. The liner is accommodated in the preservation layer and defines a recess around an outer surface of an end thereof. The fixing frame is fitted to the recess of the liner. Tabs extend from the fixing frame and define first through holes therein. The temperature controlling unit is mounted on and connecting with an end of the liner and includes a chip, a thermal element and a fan. The bottom lid encloses an end of the body and has a first wall and a second wall. Retention holes are defined in the first wall, and retention elements extend through the fixing holes of the first wall and the first through holes of the tabs to attach the tabs to the bottom lid. A partitioning wall is formed on substantially a middle of the second wall and defines a slot for corresponding to the fan. First thermal holes are defined in the second wall and second thermal holes are defined in the first wall.

To enable a further understanding of said objectives and the technological methods of the invention herein, brief description of the drawings is provided below followed by detailed description of the preferred embodiments.

### BRIEF DESCRIPTION OF THE DRAWING

FIG. 1 is a perspective view of a vacuum flask according to the present invention.

FIG. 2 is an exploded view of the vacuum flask of FIG. 1.

FIG. 3 is a cross-sectional view of the vacuum flask of FIG. 1.

### DETAILED DESCRIPTION OF THE PREFERRED EMBODIMENTS

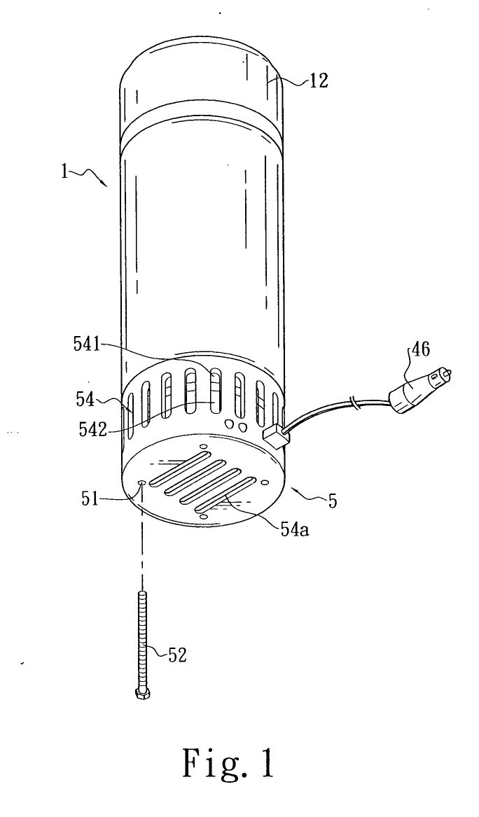

With reference to FIGS. 1 to 3, a vacuum flask in accordance with the present invention comprises a body 1, a liner 2, a fixing frame 3, a temperature controlling unit 4 and a bottom lid 5. The bottom lid 5 is reliably assembled and easily detached. Meanwhile the vacuum flask effectively gives out heat produced by the temperature controlling unit 4.

The body 1 forms a preservation layer 11 on an inner peripheral thereof. A top lid 12 is mounted on an end of the body 1 by screw.

The liner 2 is accommodated inside the preservation layer 11 and defines a cavity 21 therein for holding liquid. An opening 22 is defined at an end of the liner 2 and communicates with the cavity 21. A capsule 23 is provided to enclose the opening 22. A recess 24 is defined around an outer surface of another end of the liner 2 and opposite the opening 22. A groove 25 is defined on an outer surface of the liner 2 and adjacent to the recess 24.

The fixing frame 3 is fitted to the recess 24 of the liner 2. Tabs 31 extend outwardly from an outer surface of the fixing frame 3 and define first through holes 311. A pair of fixing portions 32 is formed on the fixing frame 3 and is opposing to each other. Fixing elements 33 are provided to cooperate with the fixing portions 32 to engage the fixing frame 3 onto the recess 24. The fixing frame 3 further defines second through holes 34 in appropriate portions thereof.

The temperature controlling unit 4 is mounted on an end of the liner 2 and connects with the liner 2. The temperature controlling unit 4 includes a chip 41, a thermal element 42 engaging the chip 41, and a fan 43 on the thermal element 42. The chip 41 is mounted on the groove 25 of the liner 2. A socket 44 and an instruction light 45 respectively electrically connect with the chip 41. The socket 44 is used for connecting with vehicle power supply 46, thereby providing power for the vacuum flask. The vehicle power supply plugs into the socket 44 positively or negatively, and correspondingly the vacuum flask remains heat or cold. The chip 41 has a temperature controlling element 47, which extends through the first through holes 34 of the fixing frame 3 and hitches appropriate position of the recess 24 of the liner 2. The bottom lid 5 encloses another end of the body 1 and opposite to the top lid 12. The bottom lid 5 has a first wall (not labeled) and a second wall (not labeled) substantially perpendicular to the first wall. Retention holes 51 are defined in the first wall, and retention elements 52 extend through the fixing holes 51 of the first wall and the first through holes 311 of the tabs 31 to attach the tabs 31 to the bottom lid 5. A partitioning wall 53 is formed on substantially a middle of the second wall and is substantially parallel to the first wall. The partitioning wall 53 defines a slot 531 for corresponding to the fan 43. First thermal holes 54 are defined in the second wall, and second thermal holes 54a are defined in the first wall. The partitioning wall 53 divides the first thermal hole 54 into upper holes 541 and lower holes 542. A socket hole 55 and a light hole 56 are respectively distributed in appropriate positions of he bottom lid 5 for accommodating the socket 44 and the instruction light 45.

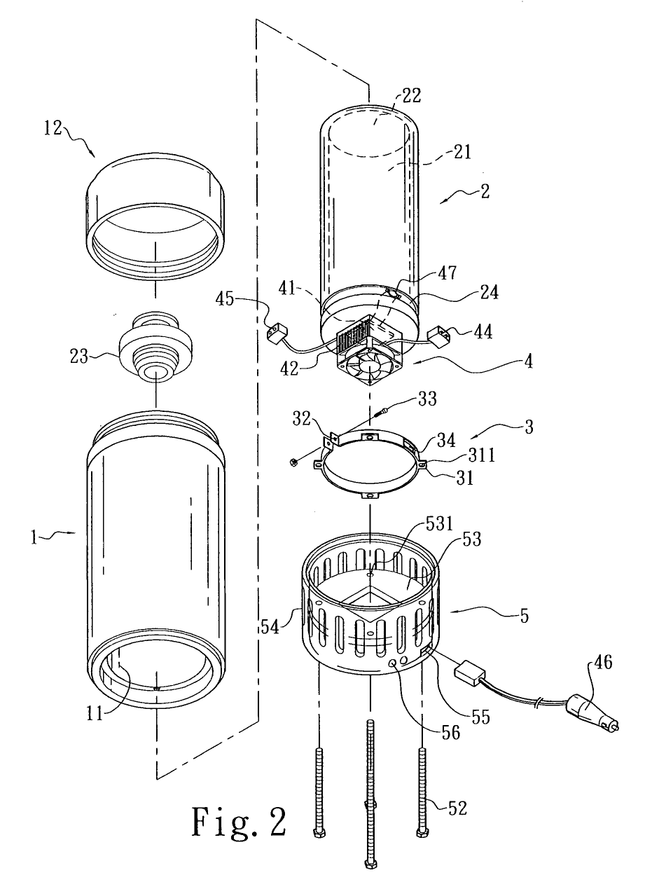

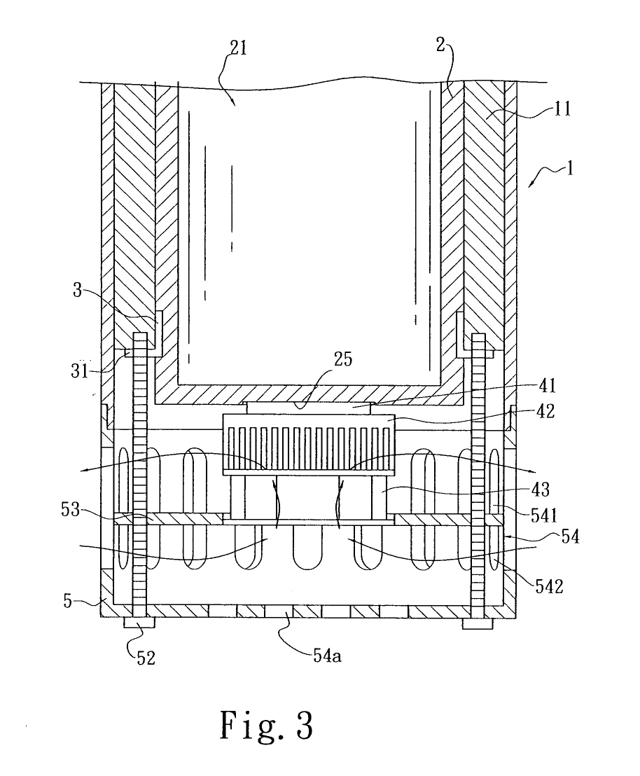

Referring to FIGS. 2 and 3, in assembly, the fixing frame 3 firstly surrounds the recess 24 of the liner 2. The fixing portions 32 and the fixing elements 33 cooperate with each other to retain the fixing frame 3 on the recess 24. The retention holes 51 of the bottom lid 5 are align with the first through holes 311 of the tabs 31. The retention elements 52 extend through the retention holes 51 and the first through holes 311 for locking the fixing frame 3 and the bottom lid 5. The bottom lid 5 is detached from the body 1 merely when the retention elements 52 are removed.

In assembly the slot 531 of the partitioning wall 53 corresponds to the fan 43 so that when the fan 43 works, external air is inhaled from the lower holes 542 of the first thermal holes 54, through the slot 531 and into the fan 43. Then the fan 43 guides the air into the thermal element 42. Finally the air is exhaled from the upper holes 541 of the first thermal holes 54. Thus heat produced by the chip 41 does not remain inside the bottom lid 5, thereby effectively giving out heat. The air inside the bottom lid 5 can send out even if the vacuum flask stands upright and the second thermal holes 54a are obstructed.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A vehicle vacuum flask comprising:
a body forming a preservation layer on an inner peripheral thereof, a top lid being mounted on an end of the body;
a liner being accommodated inside the preservation layer and defining a cavity therein for holding liquid, an opening being defined at an end of the liner and communicating with the cavity, a recess being defined around an outer surface of another end of the liner and opposite the opening;
a fixing frame being fitted to the recess of the liner, tabs extending from the fixing frame and defining first through holes therein;
a temperature controlling unit being mounted on and connecting with an end of the liner, and including a chip, a thermal element engaging the chip, and a fan on the thermal element, a socket and an instruction light respectively electrically connecting with the chip; and
a bottom lid enclosing another end of the body and opposite to the top lid, the bottom lid having a first wall and a second wall, retention holes being defined in the first wall, and retention elements extending through the fixing holes of the first wall and the first through holes of the tabs to attach the tabs to the bottom lid, a partitioning wall being formed on substantially a middle of the second wall and defining a slot for corresponding to the fan, first thermal holes being defined in the second wall and second thermal holes being defined in the first wall.

2. The vehicle vacuum flask as claimed in claim 1, wherein a capsule is provided to enclose the opening of the liner.

3. The vehicle vacuum flask as claimed in claim 1, wherein a groove is defined on an outer surface of the liner and adjacent to the recess.

4. The vehicle vacuum flask as claimed in claim 1, wherein the fixing frame further defines second through holes in appropriate portions thereof.

5. The vehicle vacuum flask as claimed in claim 1, wherein a pair of fixing portions is formed on the fixing frame and is opposing to each other, and wherein fixing elements are provided to cooperate with the fixing portions to engage the fixing frame onto the recess.

6. The vehicle vacuum flask as claimed in claim 1, wherein the chip has a temperature controlling element.

7. The vehicle vacuum flask as claimed in claim 1, wherein the socket is used for connecting with vehicle power supply, thereby providing power for the vacuum flask.

8. The vehicle vacuum flask as claimed in claim 1, wherein a socket hole and a light hole are respectively distributed in appropriate positions of he bottom lid for accommodating the socket and the instruction light.
